(19) United States
(12) Patent Application Publication
(10) Pub. No.: US 2026/0315299 A1
(43) Pub. Date: Oct. 15, 2026

(54) WEARABLE SHOULDER EXOSKELETON

(71) Applicant: University of Idaho, Moscow, ID (US)

(72) Inventors: Joel C. Perry, Moscow, ID (US); Jeremiah Schroeder, Boise, ID (US); Zhihui Wang, Seattle, WA (US); Alex C. Stella, Bonners Ferry, ID (US); Christopher Bitikofer, Moscow, ID (US)

(73) Assignee: University of Idaho, Moscow, ID (US)

(21) Appl. No.: 19/647,421

(22) Filed: Apr. 14, 2026

Related U.S. Application Data
(60) Provisional application No. 63/788,434, filed on Apr. 14, 2025.

(51) Int. Cl. A61H 1/02; B25J 9/00

(52) U.S. Cl. CPC A61H 1/0285; B25J 9/0006; A61H 2201/1207; A61H 2201/165

(57) ABSTRACT

A wearable exoskeleton device can include a support member configured to be releasably coupled to a subject's arm above the elbow, a transmission mechanism coupled to the support member and configured to transmit force from one or more energy storage elements to generate a torque about a shoulder region of the subject, a torso support structure configured to be worn on a torso of the subject, and a ball and socket pivot coupled to the transmission mechanism via a second shaft, the ball and socket pivot configured to be coupled to the torso support structure. The transmission mechanism is configured to at least partially offset gravitational loading of the subject's arm during movement.

### CROSS-REFERENCE TO RELATED APPLICATIONS

This application claims the benefit of U.S. Provisional Application No. 63/788,434 filed on Apr. 14, 2025, which is hereby incorporated herein by reference in its entirety.

### ACKNOWLEDGMENT OF GOVERNMENT SUPPORT

This invention was made with government support from the National Institutes of Health (NIH) CTR-IN Pilot Grant Award under grant number U54 GM104944 awarded by National Institute of General Medical Sciences (NIGMS), National Institutes of Health (NIH). The government has certain rights in this invention.

### FIELD

The present application relates to a passive wearable exoskeleton for upper extremity support.

### BACKGROUND

Cerebral damage from stroke leaves about half of survivors with long-term impairment in the arm and hand, leading to significant disability in activities of daily living (ADLs). One-sided impairment (hemiparesis) is one of the most common post-stroke symptoms, marked by weakness and abnormal muscle synergies (groups of muscles that contract together). During active self-support of the impaired arm against gravity, the flexion synergy causes simultaneous contraction of biceps, forearm supinators, wrist flexors, and finger flexors. When severe, the combined contraction pattern restrains the hand close to the torso, limiting the ability to reach for objects.

Intensive rehabilitation, even in the chronic phase (>6 months post-stroke), leads to better functional outcomes. However, gains in performance are often used to justify continuation of care, and many clinical assessment scores plateau (due to insensitivity of metrics) before functional recovery can be fully reached. Given these facts, it is probable that early discharge of partially rehabilitated patients increases the population of individuals with long-term impairment who are unable to incorporate their affected arm into ADLs without external assistance. These individuals develop (and are taught in therapy) compensation strategies that rely on the unimpaired limb. Unfortunately, this approach contributes to the decline and further neglect of motor function in the impaired limb.

Provision of gravity support to the hemiparetic arm can, in many cases, improve active (i.e., self-driven) range of motion (AROM), facilitating greater functional use of the arm. Chair-mounted mobile arm supports (MASs) have been used by wheelchair-bound individuals for decades to increase range of motion and function of individuals with severe weakness. MASs also work to improve range of motion and function after stroke but are not available as wearable body-mounted systems. The primary limitations have been related to device size and weight, aesthetics (e.g., profile and appearance), and/or a low level of perceived benefit considering the limitations. Successful implementation of body-mounted systems intended for long-term home use necessitates design improvements to ensure that devices are subject-friendly and fit subjects securely, particularly since they are intended to be used in environments with little or no professional supervision. Creating subject independence and establishing ease ofuse for donning/doffing and adjustment processes is a high priority since subjects at home may not have access to assistance. Existing devices for rehabilitation and upper extremity support have drawbacks such as: being mounted to a chair or other fixed object, being bulky and heavy, and being impractical for daily use.

Accordingly, a need exists in the art for improved wearable exoskeleton devices to address the issues identified.

### SUMMARY

Arm use and function are inextricably linked. Nonuse leads to functional decline, while sufficient usage leads to maintenance and further improvement. Many individuals with impairment are discharged from therapy with functional levels that are too low to promote self-use of arm and hand function at home. However, with gravitational support to the arm, some of these same individuals could experience immediate improvements in reachable workspace. The disclosed examples of a custom wearable shoulder exoskeleton are configured to increase arm function and usage. In some examples, the wearable shoulder exoskeleton utilizes variable levels of gravitational support, the effects of which were evaluated for three subjects with chronic impairment from stroke, measuring planar reach area during a single session (assisted vs unassisted). Baseline arm use at home with wrist-mounted activity trackers was also recorded to evaluate the amount of use vs. non-use of the impaired limb during daily activities. With exoskeleton assistance, subject achieved average gains in planar reach area of 11%, 1.3%, and 14.2% in the transverse, sagittal, and frontal planes, respectively, relative to unimpaired function. Baseline unassisted arm usage was also measured by numerically integrated accelerometry-based activity counts which may offer a quantitative way to compare the difference in arm usage with and without provision of an assistive exoskeleton.

The various innovations of this disclosure can be used in combination or separately. This summary is provided to introduce a selection of concepts in a simplified form that are further described below in the detailed description. This summary is not intended to identify key features or essential features of the claimed subject matter, nor is it intended to be used to limit the scope of the claimed subject matter. The foregoing and other objects, features, and advantages of the disclosure will become more apparent from the following detailed description, claims, and accompanying figures.

### BRIEF DESCRIPTION OF THE DRAWINGS

FIG. 1 is a perspective view of a wearable passive exoskeleton device, according to one example.

FIG. 2A shows a subject in an exemplary testing set up.

FIGS. 2B-2C show an exemplary testing set up where the subject is wearing the exoskeleton device of FIG. 1.

FIGS. 3A-3E show a subject completing an exemplary testing protocol.

FIGS. 3F-3J show a subject completing an exemplary testing protocol wearing the exoskeleton device of FIG. 1.

FIG. 4 is a graph showing an active range of motion for arm reach as measured by hand displacement in the transverse plane. Healthy-side range of motion has been mirrored across the sagittal plane for comparison.

FIG. 5 is a graph of arm reach range of motion in the transverse, frontal, and sagittal planes with and without assistance from the exoskeleton device of FIG. 1.

FIG. 6 is a graph of the activity comparison between a subject's unimpaired arm and impaired arm over a 24-hour period.

FIG. 7 is a graph comparing the impaired and unimpaired integrated counts over 24 hours (midnight to midnight) for all subjects.

FIGS. 8-9 show additional views of the exoskeleton device of FIG. 1.

FIG. 10 shows another view of the exemplary testing setup of FIG. 2A.

FIG. 11 illustrates a schematic view showing a series cam arrangement for use with the exoskeleton device of FIG. 1.

FIG. 12 illustrates a schematic view showing a series cam disposed on a first shaft.

FIG. 13 illustrates a schematic view showing a series cam disposed on a second shaft.

FIG. 14 illustrates a schematic view of two series cams coupled in series and configured to be disposed along a subject's forearm and upper arm.

FIG. 15 illustrates a perspective view of the exoskeleton device of FIG. 1 including a second support member.

FIG. 16 illustrates another perspective view of the exoskeleton device of FIG. 15.

FIG. 17 illustrates a close up view of a series cam mechanism, with portions of the cams shown translucently, according to one example.

### DETAILED DESCRIPTION

### General Considerations

For purposes of this description, certain aspects, advantages, and novel features of examples of this disclosure are described herein. The disclosed methods, apparatus, and systems should not be construed as being limiting in any way. Instead, the present disclosure is directed toward all novel and nonobvious features and aspects of the various disclosed examples, alone and in various combinations and sub-combinations with one another. The methods, apparatus, and systems are not limited to any specific aspect or feature or combination thereof, nor do the disclosed examples require that any one or more specific advantages be present or problems be solved.

Although the operations of some of the disclosed examples are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one of ordinary skill in the art.

As used in this application and in the claims, the singular forms “a,” “an,” and “the” include the plural forms unless the context clearly dictates otherwise. Additionally, the term “includes” means “comprises.” Further, the term “coupled” generally means physically, mechanically, chemically, magnetically, and/or electrically coupled or linked and does not exclude the presence of intermediate elements between the coupled or associated items absent specific contrary language.

As used herein, “e.g.” means “for example,” and “i.e.” means “that is.”

### I. Introduction

Mobile arm supports have been used for decades to increase the active range of motion of impaired limbs. Commercial versions are mounted to tables or wheelchairs, while only a few prototypes have been directly mounted to subjects. Existing examples of body-mounted MASs include the WREX and the WREX Mini. A number of wearable exoskeletons are now available, however, such devices are targeted toward able-bodied subjects in industrial settings, aiming to reduce shoulder strain during repetitive overhead tasks. While their acceptance in the workplace continues to grow, similar wearable products have not yet emerged for individuals with impairment.

Particularly evident in the US, the need for rehabilitation services is outpacing the supply of physical and occupational therapists, putting strain on the rehabilitative care system. Despite growing shortages, it is known that function at discharge significantly impacts future recovery trends. Patients who are discharged with higher function have been shown to be more likely to enter a positive cycle of continued use and recovery. In comparison, those with lower function are more likely to enter a negative cycle of disuse and decline. Wearable assistive exoskeletons offer a way to lower the barrier to spontaneous use of the impaired limb at home. Since patients spend a significant amount of time at home after discharge, devices that target increasing arm use in this setting have the potential to maintain or improve their function. Toward this objective, disclosed herein are examples of a wearable shoulder exoskeleton. The device aims to provide gravity support to a single arm, reducing shoulder effort and the undesirable synergies that typically impede reaching. Other important target characteristics that have shaped the design include: weight, durability, fit, comfort, ease of use, and safety.

Previous research has been conducted on the use of natural latex rubber as an energy storage material for a passive support device. When properly sized and pre-strained, natural rubber springs perform comparably to conventional metal springs with respect to hysteresis. They also provide more energy storage relative to their weight making them ideal for a body-mounted passive device such as the devices disclosed herein.

There is a significant body of literature that demonstrates that gravity balancing the arm of subjects with chronic impairment from stroke can increase active range of motion (AROM). A number of passive arm balancers operate on this principle and are commercially available. However, existing systems are either mounted to a table or chair. There are currently no available body-mounted commercial solutions, presumably due to the challenges of doing so with sufficient weight, comfort, rigidity, friction, profile, cost, or a combination of these.

### II. Examples of the Disclosed Technology

The devices disclosed herein are body mounted exoskeletons configured to improve the active range of motion in the arm of a subject. Individuals who have had strokes commonly suffer from impairments in their upper extremities, for example, chronic hemiparesis, abnormal muscle synergies, severe tone, and/or weakness from non-use. Also described herein are methods of analyzing arm use metrics in individuals with impairment using off-the-shelf wrist-mounted activity trackers as a means to evaluate the effectiveness of assistance provision in a non-clinical environment, such as at the subject's home.

As mentioned previously, existing solutions and devices for rehabilitation of the upper extremities have significant drawbacks, such as (1) being mounted to a chair or other fixed object, (2) being bulky and/or heavy, and/or (3) being impractical for daily use. Accordingly, the disclosed device addresses these issues by being wearable, lightweight, and passive (e.g., not requiring electricity).

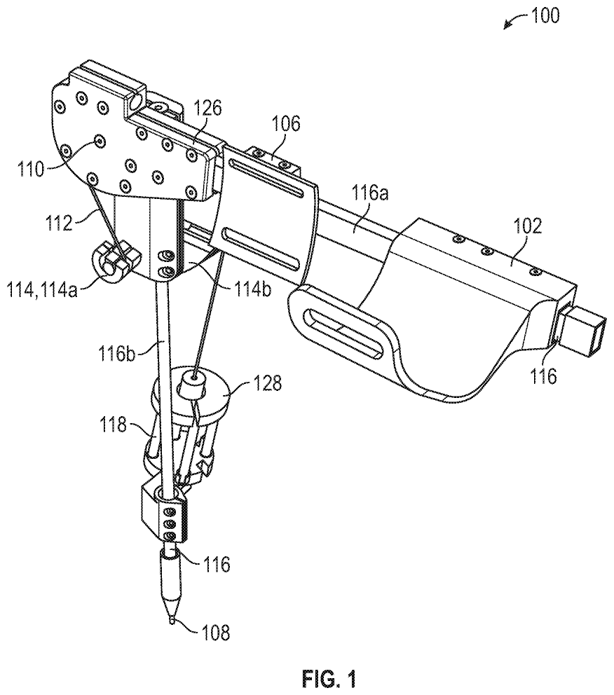

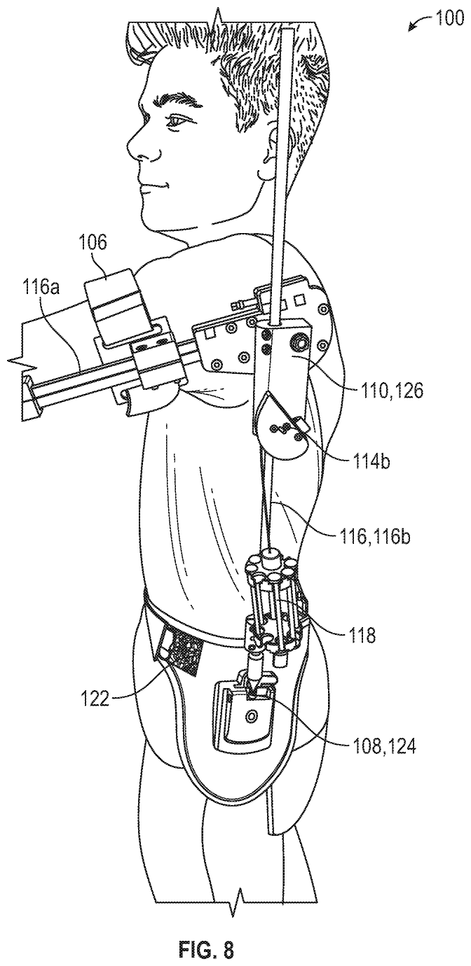

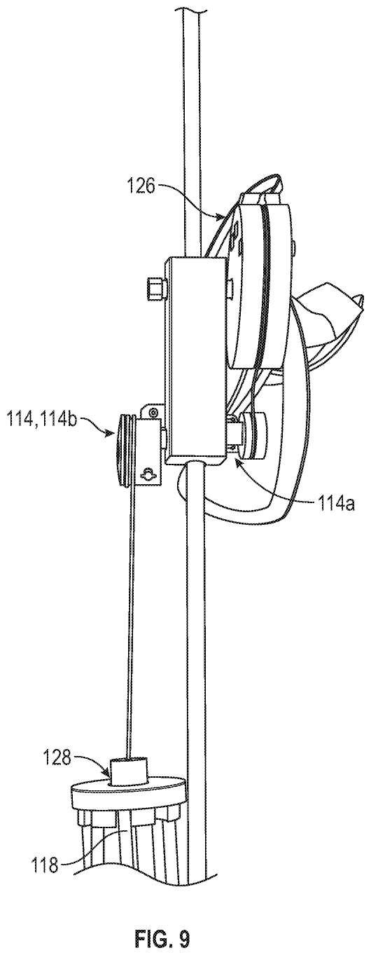

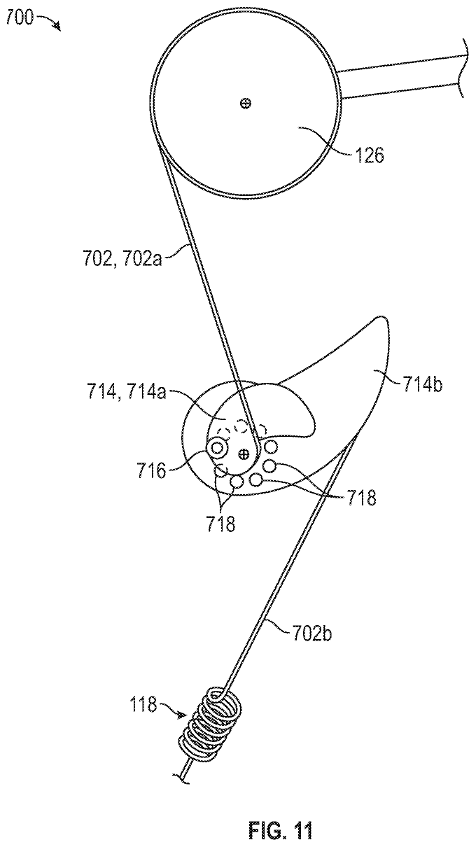

FIG. 1 shows an exemplary wearable shoulder exoskeleton device 100. Exoskeleton device 100 is a lightweight, low-profile, and low-friction wearable exoskeleton that supports the upper limb against gravity. Exoskeleton device 100 is a non-powered, passive device that is designed to allow for adjustability in the assistive force profile delivered to the arm which provides customization options based on the subject's needs (e.g., level of impairment, type of impairment, bodyweight, etc.). Support can be provided to one or both arms. FIGS. 8-9 show additional views of the exoskeleton device 100, and FIGS. 11-14 illustrate schematic views of various series cam systems or cam arrangements that can be used as part of the exoskeleton device 100.

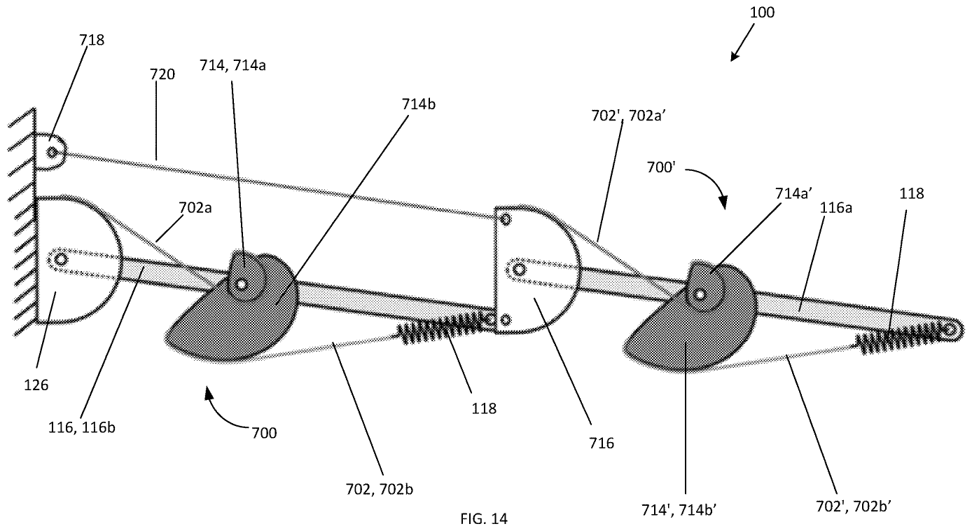

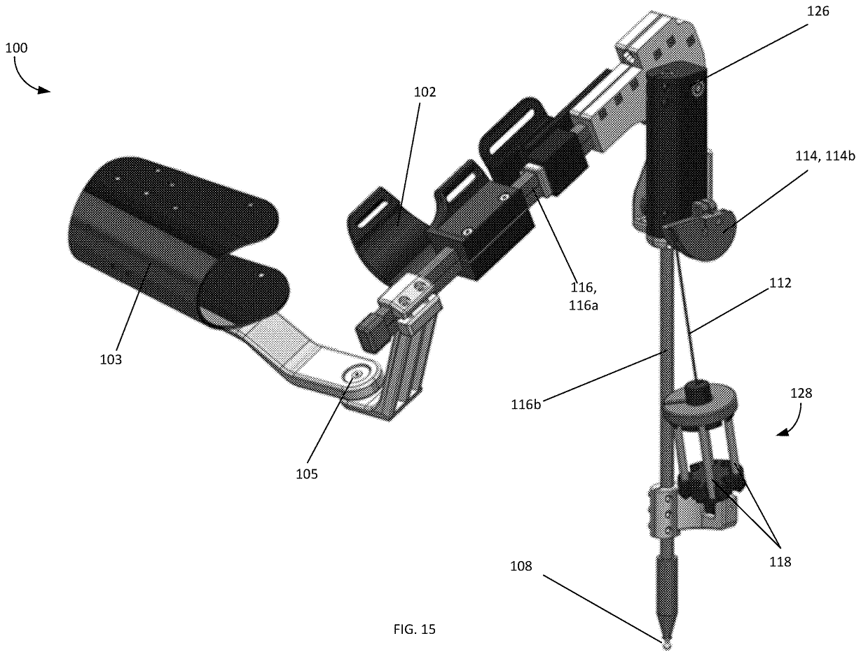

The exoskeleton device 100 can generally comprise a first support structure (which can comprise one or more support members, such as support member 102 and support member 103) configured to be releasably coupled to a subject's arm (e.g., above the elbow), a shoulder pulley 126 coupled to the support member 102 via a first shaft 116a, the shoulder pulley being coupled to a passive force transmission system including an energy storage element (e.g., comprising one or more flexible force-transmission elements such as springs 118) configured to generate an assistive force and a variable transmission mechanism such as a series wrapping cam configured to convert the assistive force into a torque about a shoulder region of the subject. As mentioned, in some examples, the first support structure can comprise a first support member 102 configured to releasably couple a portion of the subject's arm and a second support member 103 also configured to be releasably coupled to a portion of the subject's arm. For example, the first support member 102 can be coupled to the subject's upper arm region and a second support member 103 (see FIG. 15) coupled to the subject's forearm below the elbow. In some such examples, such as shown in FIG. 15, the first support member 102 and second support member 103 can be coupled to one another via an elbow joint 105 (which can be the same or similar to elbow joint 716 described with respect to FIG. 14).

The exoskeleton device further comprises a second support structure (i.e., a torso support structure) configured as a waistbelt 122 to be worn around the subject's waist, and a ball and socket pivot 108 coupled to the shoulder pulley via a second shaft 116b, the ball and socket pivot 108 configured to be coupled to the waistbelt 122. The passive force transmission system can couple the first support structure (including support members 102 and/or 103) to the second support structure 122 in order to at least partially offset gravitational loading of the subject's upper limb during movement of the upper limb relative to the torso.

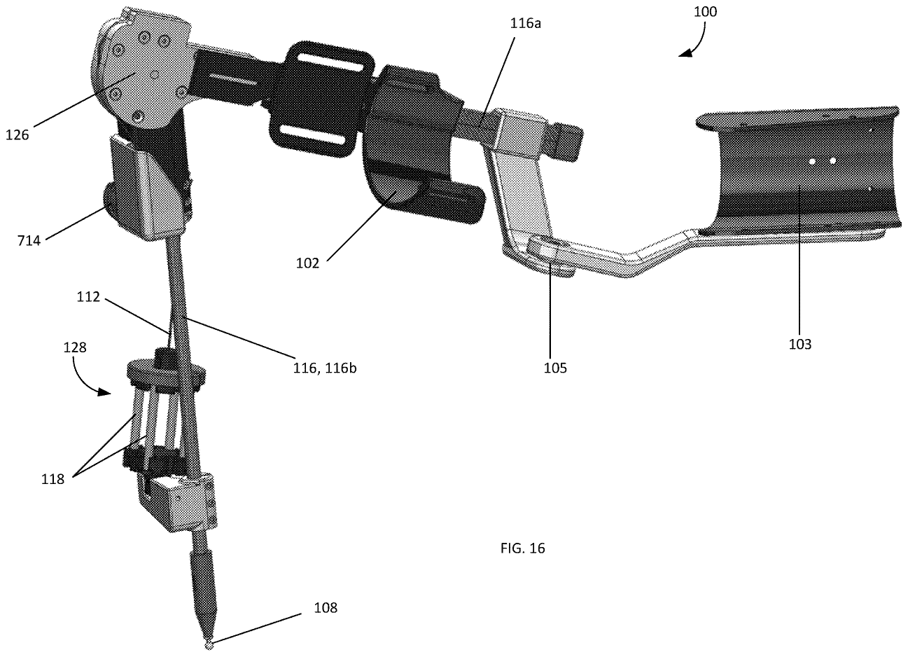

In some examples, the support member 102 is coupled to the subject's arm above the elbow. In other examples, the support member 102 is coupled to the subject's arm below the elbow. In still other examples, the support member 102 is a first support member coupled to the subject's arm above the elbow, and the device 100 comprises a second support member (e.g., support member 103) coupled to the subject's arm below the elbow with or without a passive joint (e.g., elbow joint 105) allowing elbow extension in between. FIGS. 15-16 illustrate an implementation of the exoskeleton device 100 that includes the first support member 102 and the second support member 103 coupled to one another via elbow joint 105.

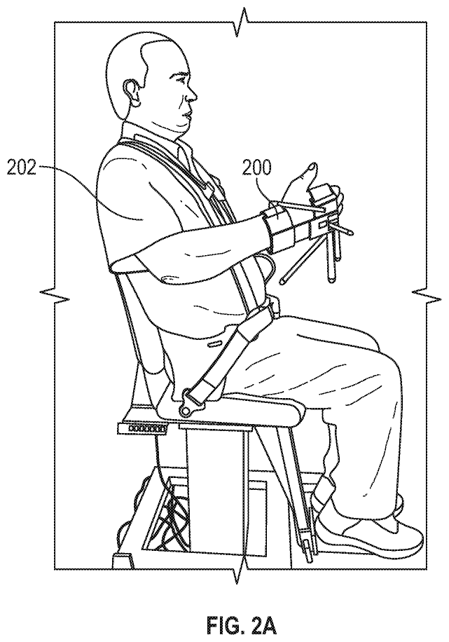

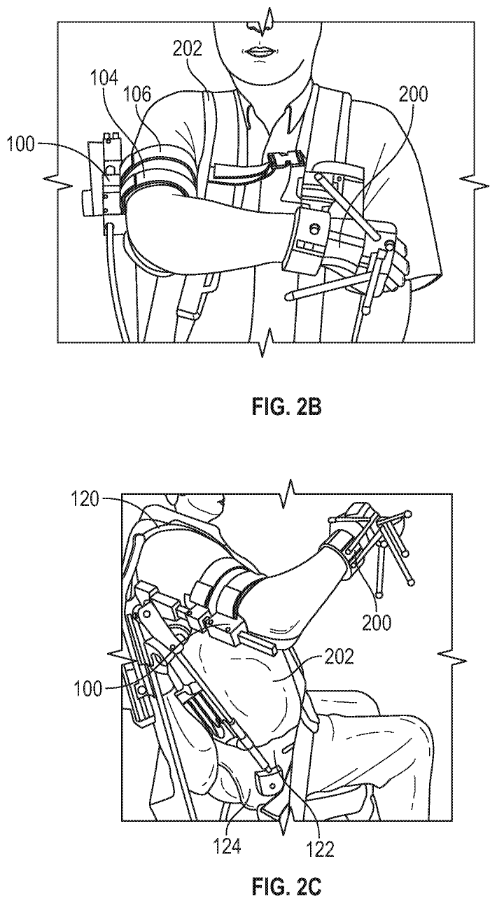

In some examples, the subject's arm is strapped to a curved support (also referred to as a support member or “upper arm support”) 102 just above the elbow. The support 102 is contoured for comfort and range of motion. The device 100 is kept aligned with and close to the subject's upper arm by two straps (see e.g., straps 104, 106 shown in FIG. 2B). The first strap 104 can couple the subject's arm to the support 102, and the second strap 106 can hold the exoskeleton 100 and the subject's arm in contact near the subject's shoulder.

The exoskeleton device 100 uses a ball and socket pivot 108 located near the hip and a single horizontal axis 110 and shoulder pulley 126 located near the subject's shoulder and coupled to the support member via a first shaft 116a. As can be partially seen in FIG. 2C, the exoskeleton device 100 attaches to a torso support structure including a cross-body support such as a shoulder strap, a waistbelt 122, and a belt attachment 124 contoured to fit the left or right hip for comfort and weight distribution. The cross-body strap attaches to each side of the belt attachment and the hip pivot is supported between and below the attachments to the cross-body shoulder strap. The belt and strap configuration advantageously allows for the distribution of loading forces to the healthy side to avoid placing loads too close to the impaired shoulder.

Unlike existing bilateral arm support designs, single-arm support does not benefit from bilateral loading that applies pressure distribution and belt loading symmetrically and therefore requires a unique solution to maintain straps in comfortable locations. The use of one or both shoulder straps supporting downward loads from a single side of the body tends to pull strap to the loading side. This can pull the cross-body strap 120 into the neck and the near-side strap toward the impaired shoulder. The exoskeleton device 100 can include a load-distribution element, such as an under-arm orthotic torso plate suspended by adjustable straps 120 that can be coupled to the cross-body shoulder strap. The load-distribution element may comprise an under-arm orthotic torso plate or other structure configured to distribute loads across multiple torso regions. Each shoulder strap 120 can be tethered part-way down the torso (front and back) to this load-distribution element/under-arm torso plate, thereby distributing the downward support loading into three locations controlled by strap adjustment (unimpaired shoulder, impaired shoulder close to the neck, and unimpaired torso). This can advantageously prevent pulling of the cross-body strap into the neck and/or impaired shoulder.

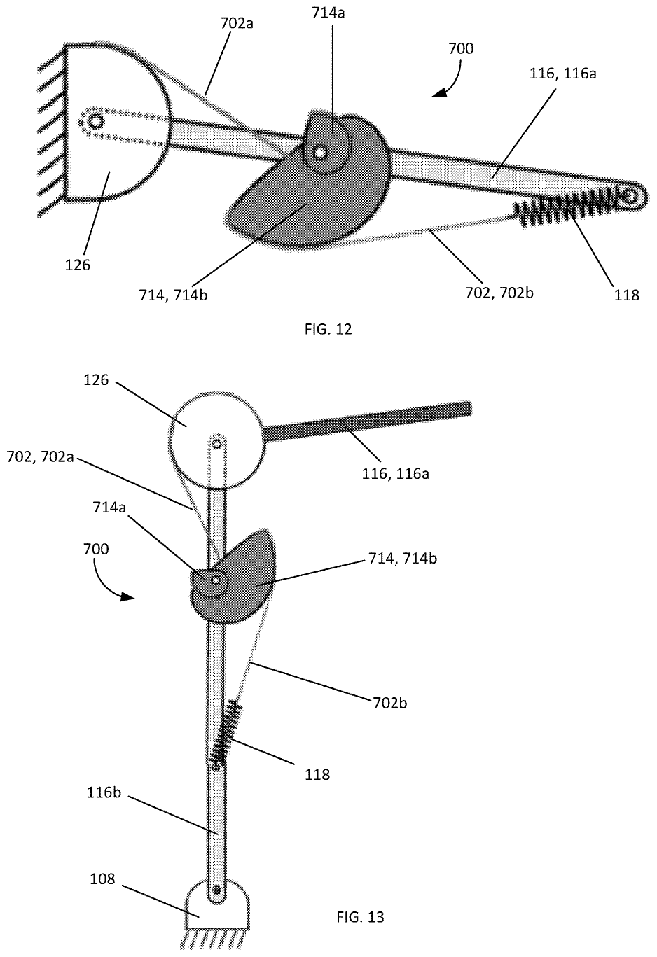

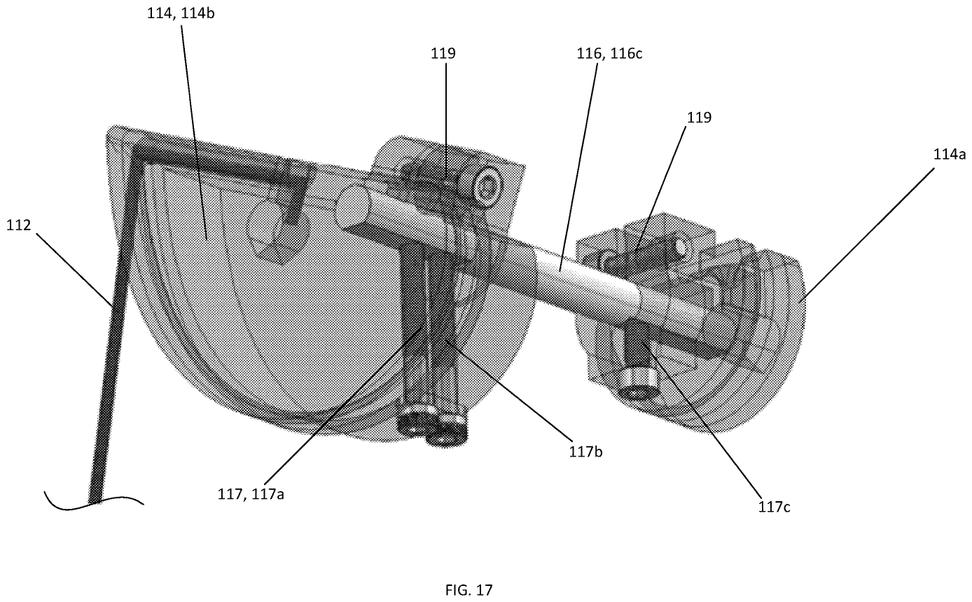

Low-stretch cables 112 transmit loads from lightweight energy storage mechanisms to cams 114 (e.g., drive cam 114a and spring cam 114b) that are secured to metal shafts 116 via fasteners 117 (see FIG. 17) that are threaded into radially tapped holes in the shaft 116. The cam mechanism can be implemented in several ways, providing the ability to transmit high loads through 3D-printed parts, multi-cable systems allowing cam profiles with convex transitions, and helical cam profiles with cable alignments that allow large angular rotations not possible with planar cams. For example, the exoskeleton device 100 can use a “series wrapping cam” (comprising multiple cams 114) as shown in FIG. 1 which can function to gravity balance the subject's arm employing the energy storage mechanism (e.g., comprising one or more flexible force-transmission elements 118, such as springs). In some implementations, the energy storage mechanism can comprise one or more flexible force-transmission elements, which can be configured as springs 118, for example, natural rubber springs. In such implementations, the springs 118 can be disposed within a spring holder 128. In other implementations, the springs can comprise any suitable material, for example, metal, elastomeric materials such as rubber/polymer, and/or composite springs such as fiberglass or carbon fiber. Other implementations of the cam system/cam arrangement can be seen, for example, in FIGS. 12-14.

In some examples, the transmission mechanism can be configured as a series cam arrangement comprising the one or more cams 114 can be coupled to the shaft(s) 116 (e.g., horizontal shaft/rod 116a and/or vertical shaft/rod 116b) using fasteners threaded into the shaft and protruding radially outwardly through a substantial section of the cams to secure each cam 114 to the shaft(s) 116 and provide adequate support and torsional loading on the cams 114 without slippage between the cam 114 and its shaft 116. In some examples, one or more of the shafts/rods 116 can have a non-circular cross section (e.g., square, rectangular, polygonal), for example, one or more of the shafts may be hollow square rods. This configuration can advantageously prevent rotation of parts clamped to the horizontal shaft 116a aligned with the upper arm. Such improvements in strength allowed larger forces to be applied throughout the exoskeleton device 100. As seen in FIG. 17, the cam system/cam arrangement including drive cam 114a and the spring cam 114b can be disposed on a shaft 116c. The cams 114 can be coupled thereto via one or more fasteners 117, for example, first and second fasteners 117a, 117b can couple the spring cam 114b to the shaft 116c and a third fastener 117c can couple the drive spring to the shaft 116c. In other examples, a greater or fewer number of fasteners 117 may be used.

The first and second fasteners 117a, 117b extend into and engage the spring cam 114b and thread into the shaft 116c to transmit loads from the cable 112 through the spring cam and into the shaft 116c with minimal cam deformation. The fastener 117c, which may in some examples be shorter than fasteners 117a, 117b, extends into and engages the drive cam 114a and threads into the shaft 116c transmitting loads from the shaft through the drive cam and to the drive cable. The cam arrangement can comprise one or more additional fasteners 119 configured to serve as shaft collar clamps to couple the cams onto the shaft 116c and eliminate play.

In some examples, the series cam can be coupled to the first shaft 116a, such as shown in FIG. 12, which can advantageously keep the second shaft 116b low profile, better supporting use in tight spaces, chairs, etc. In some examples, the series cam can be coupled to the second shaft 116b, such as shown in FIG. 13, which can advantageously decrease the mass on the upper arm, resulting in less mass to be moved by the mechanism and further creating a low profile on the first shaft 116a. In other examples, such as shown in FIG. 14 and discussed further below, the exoskeleton device 100 can comprise two cam systems coupled to one another in series, for example, with a first cam system disposed along the forearm and a second cam system disposed along the upper arm. In such configurations, it can be advantageous to mount the series cam for the shoulder to the torso shaft (i.e., second shaft 116b) and the series cam hardware for the elbow is mounted to the upper-arm shaft (i.e., first shaft 116a), leaving the forearm low profile and reducing distal mass and inertia overall.

In some prior prototypes, the exoskeleton device prevented the subject's arm from achieving a “normal” resting pose alongside the body due to a variety of factors including: (1) the cam rotation was limited to 255 degrees to avoid self-collision between the cable and cam, (2) the arm rotation was limited to 80 degrees to prevent the occurrence of convex transitions in the cam code solution, and (3) the placement of the drive cam directly below the shoulder pulley could cause a collision between the lowering horizontal rod and the drive cam on the vertical rod. To address these issues, the current exoskeleton device 100 can use one of more of the following: (1) a helical wrapping cam that uses a fine-pitch helical groove around the cam surface guiding the cable to shift at least one cable width per revolution; and (2) planar or helical multi-cable wrapping cams, which can use two or more cables connected at one end to two (or more) cams rotating together on a shared axis of revolution and the opposite ends connected to a common point on a driven object (e.g., the spring element) with the cam profiles aligned such that the first cam unwraps the first cable up to a transition point where the other cable begins wrapping around the second cam, facilitating a smooth reverse in cable movement direction at the shared endpoint.

In some examples, the exoskeleton device 100 can be formed from structural links that are created from carbon fiber rods and 3D-printed thermoplastics; springs can be constructed from natural rubber tubes; and low-stretch multifilament yarn cables (e.g., Vectran™) can be made of a commercial liquid crystal polymer braided rope to achieve an acceptable balance between device weight, rigidity, and durability. In some examples, parts under high-force loads can be formed from a micro carbon fiber filled nylon (such as Onyx®), other components can be formed from a composite material consisting of Polyethylene terephthalate glycol (PETG) and carbon fiber (referred to as PETG-CF). In some examples, one or more components can comprise high-performance thermoplastics, for example, Polyphthalamide (PPA), Polyphthalamide Carbon Fiber (PPA-CF), Polyether ether ketone (PEEK), and/or Polyetherimide (PEI).

### III. Methods of Testing

### A. Testing Procedure

A study was performed including four subjects with arm impairment to gauge arm mobility and usage. Each subject had experienced a single stroke more than six months prior and had limited ability to elevate their arm against gravity.

The testing protocol was approved by the University of Idaho's Institutional Review Board (IRB Protocol #23-041). Testing included a set of intake measures followed by two sub-studies: 1) an AROM sub-study, measuring Active Range of Motion (“AROM”) with and without external assistance from a body-mounted exoskeleton; and 2) an Arm Use sub-study, measuring normal arm use in the home setting. The AROM sub-study was conducted in a laboratory setting during an initial 90-minute session, starting with informed consent, anthropometric measures, and baseline functional assessment tests. For the Arm Use sub-study, each subject was sent home with two Axivity AX6 data loggers (3-axis accelerometer and 3-axis gyro). These devices were worn on each wrist for 3-5 days to measure daily usage of the impaired and non-impaired arm. The data loggers are contained in silicone straps that are waterproof, enabling continuous wear by subjects in all daily activities (e.g., showering, washing dishes, etc.).

### B. Intake Measurements and Baseline Assessments

Intake measures included subject age, gender, height and weight, approximate time since stroke, 60-sec Box and Blocks test (BBT) scores, grip strength, and finger-thumb pinch strength (see TABLE 1). Two subjects were primarily wheelchair-bound and did not perform strength tests due to the severity of tone in their affected hands; one of these two was also withdrawn from the AROM sub-study due to the level of tone and spasticity present in the affected arm on the day of testing.

TABLE 1
Subject's intake measures. Box and Blocks Test (BBT) scores as well as
Grip and Pinch strengths provided for impaired (I) and unimpaired (U) sides.

| | | | | | Months | | BBT | BBT | Grip | Pinch |
|---|---|---|---|---|---|---|---|---|---|---|
| | | | Weight | Height | Post | Affected | Score | Score | I/U | I/U |
| Subject | Age | Sex | (kg) | (m) | Stroke | Arm | I | U | (kg) | (kg) |
| M4601 | 78 | M | 97.5 | 1.78 | 55 | L | 0 | — | — | — |
| F7302 | 51 | F | 123.8 | 1.60 | 42 | L | 0 | — | — | — |
| M6603 | 58 | M | 86.2 | 1.75 | 14 | R | 0 | 53 | 1.7/36 | 0.7/8.8 |
| M5704 | 67 | M | 99.8 | 1.88 | 28 | R | 16 | 62 | 11.6/48.5 | 2/5.4 |

### C. AROM Sub-Study: Active Range of Motion Evaluation

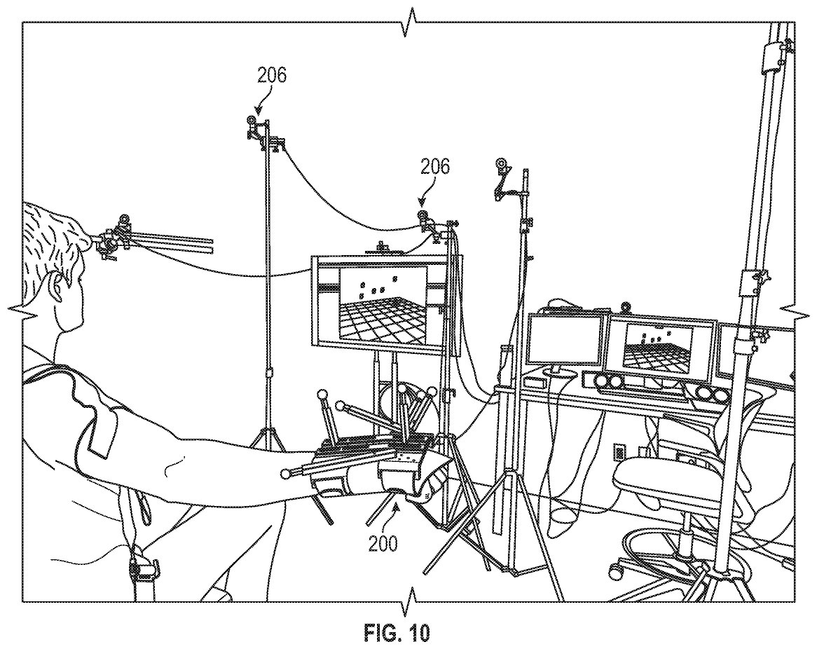

Subjects were seated and secured with a 4-point harness to an experimental chair [23] and then fit with a custom glove-based marker set 200 (see FIGS. 2A-2C). FIG. 10 illustrates an additional exemplary testing setup including the glove based marker set 200 and several infrared cameras 206. FIG. 2A shows a subject 202 performing arm reach range of motion tests without assistance from the exoskeleton device 100. FIGS. 2B-2C show the subject 202 performing arm reach range of motion tests with assistance from the exoskeleton device 100. The coordinate system (labeled 204 in FIGS. 2B-2C) indicates the X-, Y-, and Z-axes of the origin (represented by the white dot).

The marker set 200 forms a rigid body around the hand with a centroid located approximately along the grip line of the palm at the level of the metacarpophalangeal (MCP) joint. This point represents the reach and grasp distance for the subject 202. Subjects 202 were instructed to perform a planar reach motion to circumscribe the largest area possible in each of three planes (transverse, sagittal, and frontal). The movements were demonstrated on video and in-person, and subjects 202 were allowed to practice them as needed. The movements were performed first with the unimpaired side, allowing confirmation that the subject understood the task instructions, and were then repeated with the impaired side. Movements in each plane were repeated 3 to 5 times, depending on the level of difficulty for the subject. Impaired-side range of motion trials were repeated with and without assistance from the body-mounted exoskeleton.

A 5-camera motion capture setup (e.g., an OptiTrack with 5 Flex13 cameras) recorded hand movements at 120 Hz using OptiTrack's Motive software. Movement data was processed in MATLAB to compute the planar reach area. Trajectories were smoothed using MATLAB's polyarea( ) and smoothdata( ) (filter value of N=50) functions. The processed data was then used to create shapes outlining the maximum range of motion and provide estimates of the magnitude and shape of the planar reach areas. For comparison between subjects, the smoothed reach areas are plotted, illustrating the differences in size, shape, and relative location of subject reaching ability with and without exoskeleton assistance. Range of motion of the unimpaired arm was mirrored across the sagittal plane to provide a reference for impaired-side range of motion.

### D. Arm Use Sub-Study: Evaluation of Spontaneous Arm Use

To perform the arm use sub-study, an AX6 multi-sensor data logger is attached to each of the subject's wrists (left and right) via a silicone wristband, to be worn at home during the subject's normal activities. The set of on-board sensors are pre-configured using Open movement's OpenGUI with information about the subject identifier, the sensor attachment locations, and recording start and stop times. Data collection rates were set to 100 Hz with sensitivities set to ±8 g for linear acceleration and 500 degrees per second (dps) for angular velocity. The recording duration depended on the subject, but all subjects provided at least 3 days (72 hours) of continuously recorded data. Subjects were instructed to always keep the sensors on if possible and to set the AX6 devices on a stationary surface if removed.

After completion of the 3-5-day accelerometry collection, data was downloaded via the OpenGUI software, and data files were converted from raw measurements into activity counts using cwa-to-counts, a command script available in Open Movement's open-source repository. The software returns the converted data in comma-separated value (CSV) format, which was then imported into MATLAB for further processing. A moving average was taken with a window size of 10 minutes using MATLAB's envelope( ) function. Finally, MATLAB's trapz( ) function was applied to estimate the discrete integration of the accelerometry data. This was done to estimate the average overall activity level in order to compare the datasets of impaired and non-impaired arm usage.

### IV. Testing Results

### A. Arm Range of Motion Evaluation (AROM Sub-Study)

Provision of gravity assistance to the shoulder of individuals with significant impairment in the arm and hand produced varying changes in active range of motion. Referring to Table 2, subject M6603 saw the highest relative gains in reach range of motion (relative to baseline performance), while subject M5704 saw the highest absolute gains (relative to healthy performance). Both subjects M6603 and M5704 had similar absolute gains with percentage increases relative to their unimpaired arms of 14-20% in the transverse and frontal planes while the most severely impaired of the three (subject M4601) had more modest improvements of 1.5-3.5% of healthy ROM in these planes (see Table 2).

TABLE 2
Active arm reach range of motion measures in three planes without assistance
(unassisted) and with assistance (Assisted) expressed in cm² and as
a percent of range of motion of the subject's healthy (H) side. Relative
change in range of motion area also provided with respect to (w.r.t.)
the unassisted (U) area and the healthy (H) side area.

| | | Range of Motion Area | | | | Relative | |
|---|---|---|---|---|---|---|---|
| | | Unassisted | | Assisted | | Change | |
| Subj. | Motion | | w.r.t H | | w.r.t H | w.r.t. U | w.r.t. H |
| Num. | Plane | (cm²) | (%) | (cm²) | (%) | (%) | (%) |
| M4601 | Transv. | 1.73 | 4.1 | 2.36 | 5.6 | 36 | 1.5 |
| | Sagittal | 1.20 | 2.6 | 0.95 | 2.2 | −20 | −0.5 |
| | Frontal | 3.90 | 4.4 | 7.07 | 7.9 | 81 | 3.5 |
| M6603 | Transv. | 6.42 | 1.8 | 56.1 | 15 | 774 | 14 |
| | Sagittal | 7.41 | 1.6 | 29.3 | 6.6 | 295 | 4.9 |
| | Frontal | 15.6 | 1.8 | 181.2 | 21 | 1062 | 19 |
| M5704 | Transv. | 97.5 | 24 | 173.8 | 42 | 78 | 18 |
| | Sagittal | 103.7 | 24 | 101.2 | 24 | −2 | −0.5 |
| | Frontal | 60.3 | 6.7 | 229.7 | 25 | 281 | 20 |

| | | |
|---|---|---|
| Average | 287 | 8.9 |

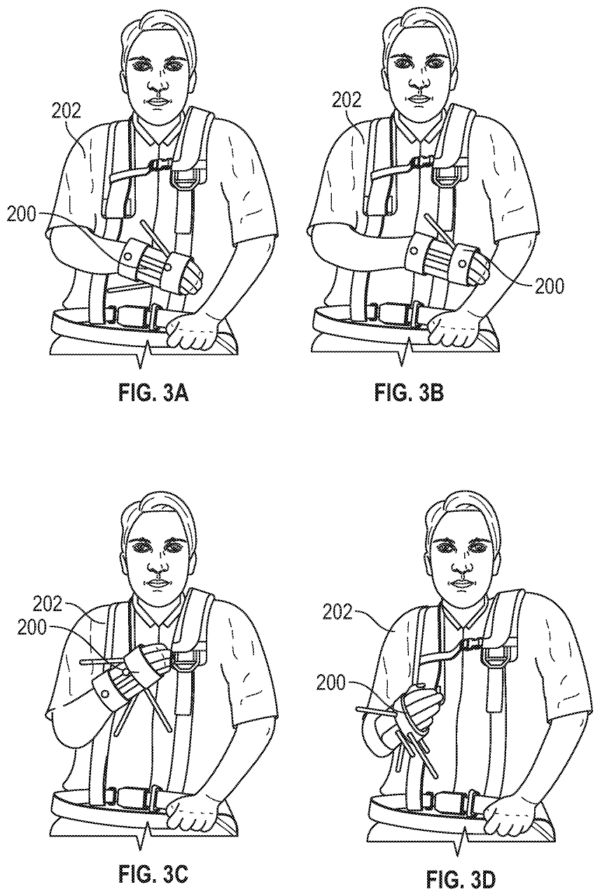

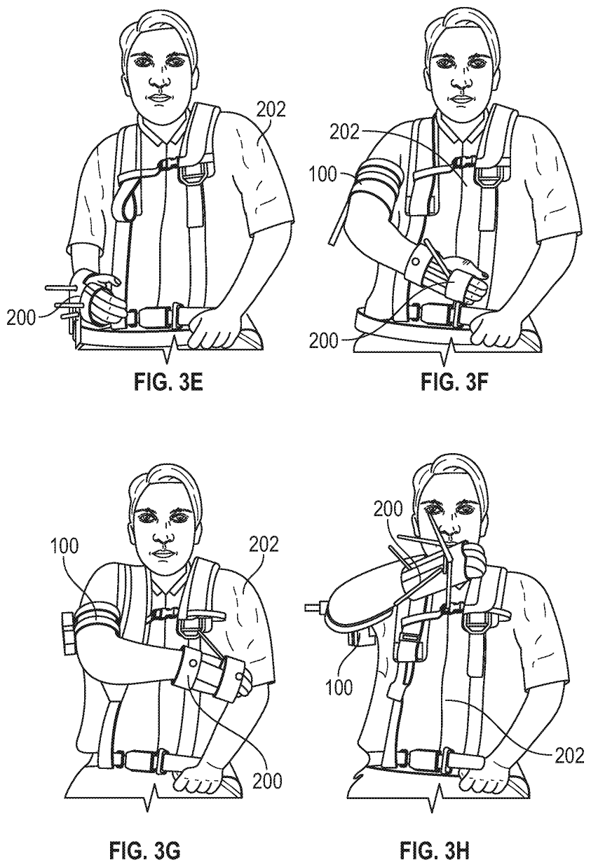

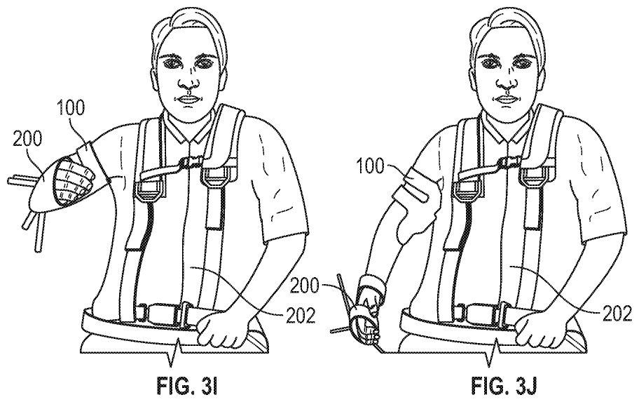

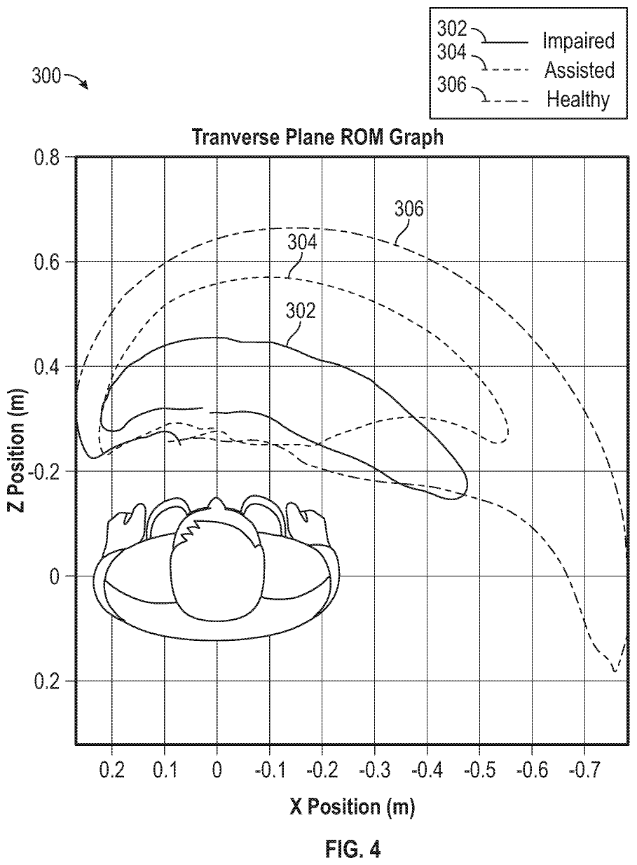

Although one subject achieved gains in all three planes, two of the three saw slight decreases in sagittal plane ROM. For all subjects, shoulder assistance increased AROM in the frontal plane the most, followed by transverse AROM, and then the sagittal AROM. Subject M5704 (referred to by reference number 202 in FIGS. 3A-3J) achieved a 20% improvement in the frontal plane (see FIGS. 3A-3J, which depict subject M5704 (reference number 202) performing an arm reach range of motion task without the device 100 (FIGS. 3A-3E) and with the device 100 (FIGS. 3F-3J)) and an 18% improvement in the transverse plane (FIG. 4), both with respect to full range of motion of the subject's healthy (left) arm. The frontal plane AROM task is shown in FIG. 3 with a sequence of images that illustrate, left-to-right, the progression of movement and top-to-bottom the relative difference between unassisted and assisted workspaces. In FIG. 4, transverse planar AROM areas are compared for impaired (assisted and unassisted) and healthy sides. FIG. 4 illustrates a graph 300 of the range of movement (ROM) in the transverse plane for an impaired arm (line 302), an assisted arm (line 304), and a healthy arm (line 306) as measured by hand displacement in the transverse plane. Healthy side (left arm) AROM has been mirrored across the sagittal plane for comparison. Without assistance, the impaired side is able to achieve 24% of the full unimpaired AROM, but with partial gravity assistance from the exoskeleton, transverse AROM increases by 18 percentage points (with respect to the healthy arm) to 42% of healthy range of motion.

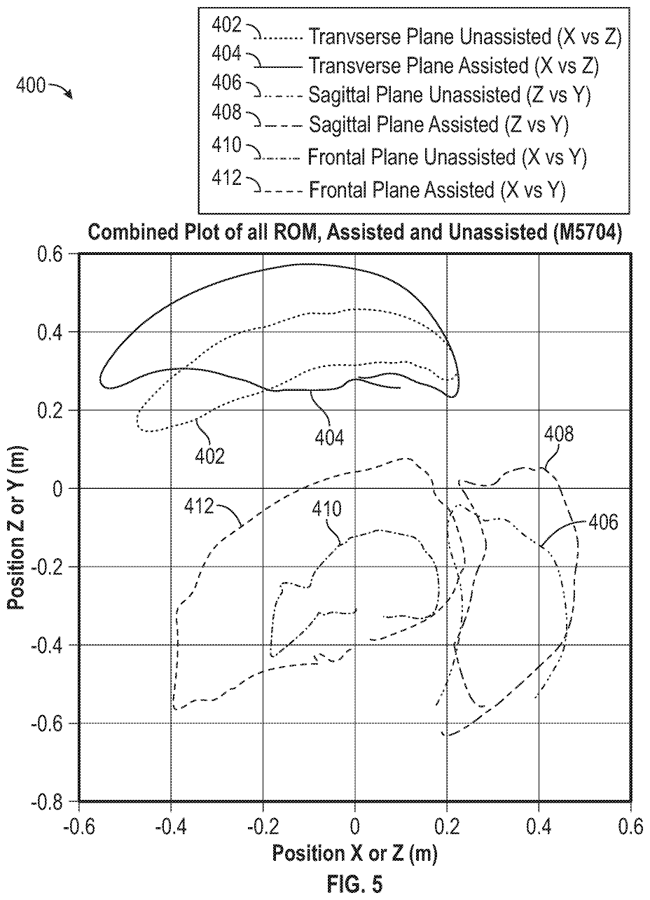

FIG. 5 depicts a graph 400 illustrating the difference between assisted (solid) and unassisted (dashed) AROM for the same subject (in this case, subject M5704) in each of the three planes. The graph 400 depicts the arm reach range of motion in the transverse plane for the subject's arm when unassisted (line 402) and assisted by the device 100 (line 404) as well as depicting the ROM in the frontal plane when unassisted (line 410) and assisted (line 412), and the ROM in the sagittal plane when unassisted (line 406) and assisted (line 408).

### B. Spontaneous Arm Use Evaluation (Arm Use Sub-Study)

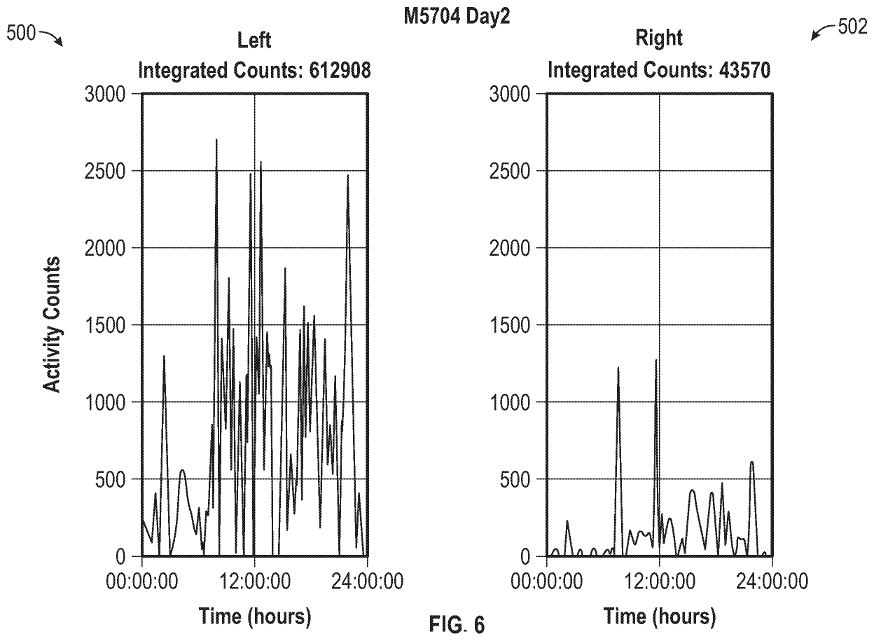

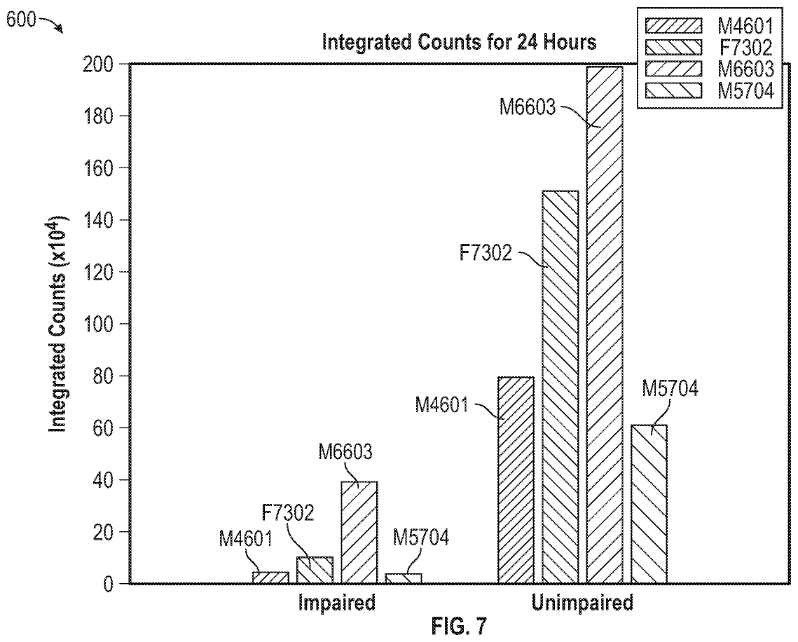

The amount of recorded activity in impaired extremities was significantly less than the unimpaired extremity for all subjects. FIG. 6 shows recorded activity from subject M5704 over a 24-hour period starting and ending at midnight. The numerically integrated counts for the impaired (right) side (see graph 502 in FIG. 6) totaled 4.35×104, while the non-impaired (left) side (see FIG. 500 in FIG. 6) totaled 61.2×104 counts. Table 3 shows integrated count values, representing the total amount of use of each arm, as well as a ratio between the level of impaired vs. unimpaired arm use for all subjects.

TABLE 3
Activity counts comparison between impaired (I) and
unimpaired (U) arms.

| | | | | | I/U |
|---|---|---|---|---|---|
| | | | | I/U | Average |
| | | | | Activity | Activity |
| Subject | | I Counts | U Counts | Ratio | Ratio |
| Number | Day | (×10⁴) | (×10⁴) | (%) | (%) |
| M4601 | 1 | 8.08 | 116 | 6.97 | 6.53 |
| | 2 | 5.08 | 80.1 | 6.34 | |
| | 3 | 4.72 | 68.9 | 6.85 | |
| | 4 | 4.94 | 84.5 | 5.85 | |
| F7302 | 1 | 2.82 | 52.5 | 5.37 | 6.8 |
| | 2 | 10.7 | 150 | 7.13 | |
| | 3 | 10.8 | 152 | 7.11 | |
| | 4 | — | — | — | |
| M6603 | 1 | 25.0 | 136.94 | 18.26 | 20.07 |
| | 2 | 39.68 | 198.73 | 19.97 | |
| | 3 | 46.26 | 213.59 | 21.66 | |
| | 4 | 19.78 | 101.98 | 19.40 | |
| M5704 | 1 | 1.53 | 17.2 | 8.90 | 6.73 |
| | 2 | 4.35 | 61.2 | 7.11 | |
| | 3 | 2.39 | 45.8 | 5.22 | |
| | 4 | 1.25 | 17.3 | 7.23 | |

FIG. 7 depicts a graph 600 showing a side-by-side comparison of integrated counts between impaired and unimpaired arms for all subjects (M4601, F7302, M6603, and M5704) over a 24-hour period (from midnight to midnight). For most subjects, the impaired side is used, on average, about 10% as much as the unimpaired limb in daily life.

### V. Discussion and Conclusions

A wearable exoskeleton was developed to lessen the shoulder effort required to support the arm against gravity with the goal of increasing active range of motion poststroke. AROM of the impaired arm with and without the exoskeleton assistance was evaluated in a laboratory setting through motion capture. Three subjects participated in the laboratory evaluation, and four also took part in an at-home assessment of arm use measured by wrist-mounted wearable trackers.

While wearing the exoskeleton, all subjects saw significant improvement in the frontal and transverse planes. Changes in the sagittal plane were more varied, with two subjects showing decreased AROM in that plane when using the exoskeleton. There are a few reasons for this effect: 1) The exoskeleton spring support design does not take into account elbow angle and therefore may under-support the arm when the elbow is extended and over-support when the elbow is flexed; 2) the direction of the range of motion task can either work with or against this under/over-support limitation; and 3) the subjects in this experiment were asked to perform the motion in the direction that would work against the support limitation, minimizing the resulting range of motion. Although this did result in a reduced range of motion over the unassisted condition for two of the subjects, the change was negligible for one, and the third subject still achieved an increased range of motion. Future subjects will perform the sagittal plane AROM tasks in both directions to compare AROM capabilities when taking advantage of the device's ability to over-support when lifting and under-support when lowering the arm.

Other constraints imposed by the current design of the device 100 are a limited ROM and inability to actively move the limb. The design currently limits the range of assistance to between 17 and 90 degrees of elevation from the side. As a passive device, it serves to amplify the subject's already existing motion capabilities, so AROM increases are dependent on the subject's strength prior to testing. This can be seen by comparing the average activity ratio and the relative increases in AROM in each subject. Those with a higher average activity ratio had higher relative changes in assisted AROM values.

Overall, the wearable exoskeleton 100 makes use of the impaired arm less strenuous. This was noticed particularly for subject M4601 who, despite having only small gains in AROM, was able to achieve the ROM with dramatically less strain as evidenced in facial and body posture. The study protocol has since been revised to allow measurement of electromyography (EMG) during the AROM assessment to evaluate muscular effort along with AROM. Regardless of whether improvements are in AROM or effort, there is potential for these improvements to increase subject motivation and ability to use their impaired arm in daily life. The goal is to adequately match subject impairment with the proper assistance level from the exoskeleton to maximize impaired arm use at home.

The preliminary work in measuring arm use at home clearly shows a difference in arm use and establishes a baseline against which to compare future measurements of arm use at home with exoskeleton assistance. The next steps of this study will send participants home with the assistive exoskeleton and monitor changes in the impaired-to-unimpaired arm use activity ratio. Following the preliminary results described herein, we expect exoskeleton assistance to produce increased activity levels in the impaired extremity, and higher scores in standardized functional assessment tests.

The designed exoskeleton 100 provides immediate improvement of subject AROM in the frontal and transverse planes of motion, and we believe it will also provide increased sagittal plane AROM if the characteristics of the gravity support are properly leveraged. We believe that these preliminary results provide strong, positive evidence of the potential benefits of wearable exoskeletons for stroke rehabilitation.

Referring now to FIG. 11, in some implementations, in lieu of or in addition to the series wrapping cam shown and described with respect to FIGS. 1 and 8-9, the exoskeleton device 100 can incorporate an adjustable series cam 700. The adjustable series cam 700 can be similar to the series wrapping cam described previously, except that the adjustable series cam 700 is configured to allow the two cams 714 (e.g., the drive cam 714a and spring cam 714b) to be selectively repositioned and locked (via a locking mechanism such as a pin 716 disposed on the drive cam 714a). This advantageously allows the subject to vary the operation range of each cam 714 and/or their relationship overlap, thereby adjusting the transmission ratio between the springs 118 and shoulder pulley 126 without having to remove and replace the cams 714 and/or springs 118.

As mentioned, the adjustable series cam 700 can comprise a locking mechanism, for example, a pin and hole locking mechanism. The locking mechanism can be configured to selectively retain the positioning of the drive cam 714a and the spring cam 714b relative to one another. In some examples, the locking mechanism can be movable between a first or unlocked position wherein the drive cam 714a and the spring cam 714b are movable relative to one another, and a second or locked position wherein the drive cam 714a and spring cam 714b are fixed relative to one another. In other examples, the locking mechanism can comprise a motor and gear. For example, the locking mechanism can comprise a low-powered motor and a “worm drive,” i.e., a gear arrangement including an interface between a screw gear (the “worm”) and a worm gear. The worm drive can function to adjust and hold the relative positions of the drive cam 714a and spring cam 714b relative to one another, and allow for automatic adjustment of the positioning.

Referring to FIG. 11, the adjustable series cam 700 can be coupled to the shoulder pulley 126 and can comprise a high tension cable 702 coupled to the drive cam 714a. The spring cam 714b can comprise a plurality of apertures/holes/openings 718. The drive cam 714a and spring cam 714b can be unlocked, rotated with respect to one another, and then relocked (e.g., by inserting the pin 716 into one of the openings 718) such that the two rotate together but with a variable relative angle between them around the shared shaft.

In some implementations, as mentioned, the locking mechanism can comprise a pin 716 and a plurality of openings 718. In some examples, the pin 716 can be disposed on the spring cam 714b and the plurality of openings 718 can be disposed on the drive came 718. In other implementations, the locking mechanism can comprise a collar clamp disposed on the shaft 116, a slot with a friction locking washer and nut, or any other mechanical locking mechanism.

The spring cam 714b surface may be flat to accommodate cables or a belt, or may be grooved to guide the cable(s) 702 (e.g., a high tension cable 702a and a low tension cable 702b) as they wrap around the cam 714b. Furthermore, the cable or belt 702 may wrap in a single plane for rotations of <360 degrees, or may be composed of a helical groove of increasing radius allowing larger rotation angles to accommodate the adjustment angle plus the series cam 700 rotation angle.

Referring to FIG. 12, as mentioned previously, in some examples the series cam 700 can be coupled to the first shaft 116a. In other examples, such as shown in FIG. 13, the series cam 700 can be coupled to the second shaft 116b between the shoulder pulley 126 and the belt 122.

Referring to FIG. 14, in some examples, the exoskeleton device 100 can comprise two series cams 700, for example, a first series cam 700 including a first drive cam 714a and a first spring cam 714b and a second series cam 700′ including a second drive cam 714a′ and a second spring cam 714b′. As shown in FIG. 14, the first series cam 700 and the second series cam 700′ can be coupled to one another in series. For example, first series cam 700 can be coupled to the second shaft 116b and second series cam 720b can be coupled to the first shaft 116a. The first and second series cams 700, 700′ can be separated by a first pulley or elbow joint 716. The first series cam 700 can further be coupled to the shoulder pulley/joint 126. In such examples, the device 100 can further comprise an anchor member 718 and an anchor tether 720 (such as a wire or cable) configured to maintain verticality of the pulley at the elbow joint allowing the device 100 to be used as a gravity balancing device for the shoulder and elbow.

In view of the many possible ways in which the principles of the disclosure may be applied, it should be recognized that the illustrated configurations depict examples of the disclosed technology and should not be taken as limiting the scope of the disclosure nor the claims. Rather, the scope of the claimed subject matter is defined by the following claims and their equivalents.

1. A wearable exoskeleton device, comprising:
a support member configured to be releasably coupled to a subject's arm above the elbow;
a transmission mechanism coupled to the support member and configured to transmit force from one or more energy storage elements to generate a torque about a shoulder region of the subject;
a torso support structure configured to be worn on a torso of the subject; and
a ball and socket pivot coupled to the transmission mechanism via a second shaft, the ball and socket pivot configured to be coupled to the torso support structure;
wherein the transmission mechanism is configured to at least partially offset gravitational loading of the subject's arm during movement.

2. The exoskeleton device of claim 1, wherein the support member is a first support member and wherein the exoskeleton device further comprises a second support member configured to be releasably coupled to the subject's arm below the elbow.

3. The exoskeleton device of claim 1, wherein the transmission mechanism comprises a cam arrangement including a plurality of cams configured to transmit force between the energy storage element and the support member, wherein at least two cams are arranged to provide variable mechanical advantage across a range of motion.

4. The exoskeleton device of claim 3, wherein at least one cam comprises a drive cam and at least one cam comprises a spring cam, and wherein both the first and second cams are coupled to a common shaft, and wherein the cams are configured to operate across different portions of a limb to provide multi-joint assistance.

5. The exoskeleton device of claim 1, wherein the transmission mechanism further comprises one or more flexible force-transmission elements comprising cables configured to transmit force between the energy storage element and the support member.

6. The exoskeleton device of claim 1, wherein a shaft comprises a non-circular cross-section configured to prevent rotation of components mounted thereon.

7. The exoskeleton device of claim 1, further comprising a cross-body support coupled to the torso support structure and configured to distribute loading forces across a torso of the subject.

8. The exoskeleton device of claim 7, further comprising a load-distribution element configured to distribute load across multiple torso locations.

9. The exoskeleton device of claim 1, wherein the ball and socket pivot is positioned proximate a hip of the subject to enable multi-axis movement of the arm.

10. The exoskeleton device of claim 1, wherein the transmission mechanism is adjustable to vary a transmission ratio between the energy storage element and the support member.

11. The exoskeleton device of claim 10, wherein the transmission mechanism comprises a drive cam, a spring cam, and a locking mechanism configured to selectively fix a relative angular position between the drive cam and the spring cam.

12. The exoskeleton device of claim 11, wherein the locking mechanism comprises a releasable engagement mechanism including a pin and a plurality of openings configured to receive the pin.

13. A wearable exoskeleton device for providing support to a subject's upper extremity, comprising:
a first support structure configured to be worn on the subject's torso;
a second support structure configured to be coupled to an upper limb of the subject;
a passive force transmission system operatively coupling the first and second support structures to one another, the passive force transmission system comprising:
at least one energy storage element configured to generate an assistive force; and
a transmission mechanism configured to apply a torque about a shoulder region of the subject based on the assistive force; and
wherein the passive force transmission system is configured to at least partially offset gravitational loading of the upper limb during movement of the upper limb relative to the torso, and wherein the wearable exoskeleton device is configured to provide the assistive force with a reduced weight and profile suitable for body-mounted use, including selection of materials and structural components to achieve a high force-to-weight ratio.

14. The exoskeleton device of claim 13, wherein the second support structure comprises a curved support member configured to be coupled to the subject's arm above the elbow.

15. The exoskeleton device of claim 13, wherein the energy storage element comprises one or more elastic elements selected to provide a high energy-to-weight ratio.

16. The exoskeleton device of claim 13, wherein the transmission mechanism comprises a cam-based transmission mechanism.

17. The exoskeleton device of claim 16, wherein the drive cam and spring cam are movable relative to one another to adjust a transmission ratio between the energy storage element and the second support structure, the transmission mechanism further comprising a locking element configured to selectively allow movement of the drive cam and spring cam relative to one another.

18. A method of assisting movement of an impaired arm of a subject, comprising:
coupling a wearable exoskeleton device to a subject, the exoskeleton device comprising a first support structure coupled to the subject's torso and a second support structure coupled to the subject's arm, the first and second support structures coupled to one another via a passive force transmission system comprising at least one energy storage element and a transmission mechanism;
adjusting an assistive force profile via the transmission mechanism;
providing passive gravitational support to the arm via the passive force transmission system; and
allowing the subject to perform arm movements with reduced effort.

19. The method of claim 18, wherein the transmission mechanism comprises a series cam including a drive cam and a spring cam.

20. The method of claim 19, further comprising modifying a relative angular position between the spring cam and the drive cam to adjust an assistive force profile.
